(19) United States
(12) Patent Application Publication
(10) Pub. No.: US 2016/0285133 A1
(43) Pub. Date: Sep. 29, 2016

(54) ELECTRODE ASSEMBLY, METHOD FOR THE PRODUCTION THEREOF, AND ELECTROCHEMICAL CELL

(71) Applicant: KARLSRUHER INSTITUT FÜR TECHNOLOGIE, Karlsruhe (JP)

(72) Inventors: Manuel BAUMEISTER, Bruchsal (DE); Sebastian HAAG, Karlsruhe (DE); Jurgen FLEISCHER, Karlsruhe (DE)

(21) Appl. No.: 15/036,173

(22) PCT Filed: Nov. 12, 2014
(86) PCT No.: PCT/EP2014/074322

§ 371 Date: May 12, 2016

(30) Foreign Application Priority Data
Nov. 15, 2013 (DE) 10 2013 019 071.1

(51) Int. Cl. H01M 10/0583; H01M 10/04

(52) U.S. Cl. CPC H01M 10/0583; H01M 10/045

(57) ABSTRACT

The invention relates to an electrode assembly (110), which comprises a layer structure with at least one first electrode (112), at least one second electrode (130) and at least one separator (116) inserted between the first electrode (112) and the second electrode (130). The first electrode (112) has here at least one first conductive band (114), the first conductive band (114) being folded in a first zigzag fold, the first zigzag fold having the effect of forming a plurality of first layers (120, 122) lying one over the other and first folding edges (134, 136) that lie opposite one another of the first zigzag fold defining a first folding direction (138) of the first zigzag fold. Furthermore, the second electrode (130) has at least one second conductive band (132), the second conductive band (132) being folded in a second zigzag fold, the second zigzag fold having the effect of forming a plurality of second layers (128, 140) lying one over the other and second folding edges (142) that lie opposite one another of the second zigzag fold defining a second folding direction (144) of the second zigzag fold. According to the invention, the first layers (120, 122) and the second layers (128, 140) are arranged parallel to one another, the first folding direction (138) and the second folding direction (144) forming an angle in relation to one another of at least 60° and of at most 120°, and the separator (116) taking the form of at least one insulating band (118), two neighboring first layers (120, 122) respectively lying one over the other in such a way that they in each case form a double layer (124, 126), and a second layer (128, 140) being respectively inserted between two double layers (124, 126).

The invention also relates to a method for producing such an electrode assembly (110) and to an electrochemical cell which comprises at least one such electrode assembly (110), at least one electrolyte, at least one first current collector for the first electrode (112) and at least one second current collector for the second electrode (130).

### FIELD OF THE INVENTION

The present invention relates to an electrode assembly, to a method for the production thereof and to an electrochemical cell, which comprises at least one such electrode assembly. In addition, the present invention relates to a method for producing the electrochemical cell and to a secondary battery, which comprises at least one such electrochemical cell.

### PRIOR ART

The prior art discloses a large number of batteries, which are usually understood as meaning an electrical interconnection of at least two electrochemical cells, which are also referred to as galvanic cells, that is preferably used for storing chemical energy and delivering electrical energy. Apart from so-called “primary batteries”, which can only be used once with respect to their life cycle, there are a large number of so-called “secondary batteries”, which can be charged with electrical energy and discharged over a large number of cycles. This requires the use of suitable active materials, which can be reversibly transformed between at least two electronic states, in order in this way to be able to convert chemical energy into electrical energy and vice versa.

An “electrochemical cell” is the term that is usually used to refer to a device which comprises two electrodes that are spatially separated from one another, to be precise a first electrode and a second electrode, which each have a different polarity and are therefore also referred to as the “cathode” and the “anode”. In the electrochemical cell, the two electrodes are on the one hand in contact with one another by way of at least one ion-conducting electrolyte, while a separator that is permeable to the ions electrically insulates the two electrodes from one another in order to avoid a short circuit. In other words: the electrochemical cell generally has a so-called “electrode assembly”, which is also referred to as an “electrode-separator assembly” and which comprises at least one first electrode, at least one second electrode and at least one separator, the electrode assembly being provided at least with the at least one electrolyte and with at least one electrical current collector for each of the two electrodes.

The prior art also discloses a large number of electrode assemblies. DE 10 2009 013 727 A1 for example describes a stack of flat electrochemical cells, each stack having a cathode plate and an anode plate, which are respectively separated by a separator membrane lying in between. A comparable arrangement is disclosed by DE 10 2011 102 847 A1.

Since the separator in many cases takes the form of an insulating strip, which may be configured for example as a membrane, electrochemical cells in which the separator is laid as an insulating band in the form of a so-called “zigzag fold” or “Z fold” are described, the zigzag fold having the effect of forming a plurality of layers lying one over the other, between which there is respectively inserted alternately a cathode plate and an anode plate. Such a configuration of the electrochemical cell can be found for example in G. Reinhart, T. Zeilinger, J. Kurfer, M. Westermeier, C. Thiemann, M. Glonegger, M. Wunderer, C. Tammer, M. Schweier and M. Heinz, Research and Demonstration Center for the Production of Large Area-Lithium Ion-Cells, in G. Schuh et al., publisher, Future Trends in Production Engineering, Springer, 2013, Proceedings of the First Conference of the German Academic Society for Production Engineering, Berlin, 2011, pages 3-11.

EP 1 278 253 B1 discloses a further electrode assembly in which both the separator and the anode respectively take the form of an insulating band and an electrically conductive band, which are together laid into a zigzag fold, this jointly formed zigzag fold of the separator and the anode forming a plurality of layers formed jointly by the separator and the anode and lying one over the other, cathode plates being respectively inserted between the jointly formed layers.

DE 38 29 541 A1 discloses an electrode assembly which has a layer structure comprising two electrodes and a separator, each electrode having a conductive band in a zigzag fold with a folding direction. The zigzag fold has the effect of respectively forming a plurality of layers lying one over the other, the two layers being arranged parallel to one another and the two folding directions being perpendicular to one another.

In particular in the case of lithium-ion batteries, electrodes of a metallic material, such as for example copper or aluminum, are often used, with a layer of an active material respectively applied on said electrodes and the active material comprising a lithium-containing anode or cathode material. An overview of materials that are often used in the field of lithium-ion batteries can be found in B. Ketterer, U. Karl, D. Möst and S. Ulrich, Lithium-Ionenbatterien: Stand der Technik und Anwendungspotential in Hybrid, Plugin-Hybrid und Elektrofahrzeugen [Lithium-ion batteries: prior art and application potential in hybrid, plugin-hybrid and electric vehicles], Karlsruhe Research Center, Scientific Reports, FZKA 7503, October 2009, pages 7-13. By contrast, lithium-ion batteries nowadays generally have graphite anodes, which are distinguished in particular by a low electrode potential and a relatively low volume expansion during the intercalation of lithium ions. Alternative anode materials are titanium oxides, preferably LiTiO₂ or Li₄Ti₅O₁₂.

As B. Ketterer, see above, further reveals, known cathode materials that are used as active materials for lithium-ion batteries generally comprise intercalation compounds of inorganic transition metal oxides, which, according to the dimensionality of a host structure for a lithium-ion diffusion in the intercalation compound, can be subdivided into one-dimensional tube structures, two-dimensional layer structures and three-dimensional frame structures. Among the compounds with a one-dimensional tube structure are transition metal compounds, for instance LiFePO₄, with an olivine structure. The two-dimensional layer structures comprise in particular LiMo₂ with M=Co, Mi, Fe or Mn, the compounds LiNi_{0.85}Co_{0.1}Al_{0.05}O₂, LiNi_{1/3}Mn_{1/3}O₂ or LiNi_{1/2}Mn_{1/2}O₂ being used in particular. Compounds with a spinel structure, such as for example LiMn₂O₄, offer a three-dimensional network for the intercalation of the lithium ions.

EP 0 869 570 B1 discloses exposing the coating of the active material that is applied to at least one side of the electrically conductive band, at least in the region of the folding edges. The resultant gaps in the coating of the active material on the electrically conductive band make it possible in particular that the electrically conductive band can be folded and laid without any damage, which could arise for example due to detachment of active material in the region of the folding edges.

Generally required are electrode assemblies that are intended to provide more power or energy at higher voltages with at the same time improved reliability. In the case of lithium-ion batteries, the known electrode assemblies have disadvantages, in particular on account of the thereby occurring expansion behavior of the materials used, in particular since malfunctions, such as for instance a high internal resistance, can often occur there even after only a short operating time. It is known for instance from lithium-ion batteries that deposits of metallic lithium or other materials, such as for example iron, in the form of tree-like structures known as “dendrites”, or else in the form of sheet-like structures, can lead to a short circuit, and consequently to complete failure of the electrode assembly and of the electrochemical cell in which the electrode assembly is located. For example, as finely divided structures, dendrites may pierce an electrode assembly in the manner of needles and in this way bring about a short circuit. Alternatively and/or in addition, dendrites may however also form around folding edges, whereby a short circuit can likewise form. Lithium deposited in a sheet-like form may additionally form a possibly undesired electrically conductive connection from an electrode to the electrolyte. The lifetime of a battery that has at least one such faulty electrode assembly can also be significantly reduced in this way.

### OBJECT OF THE INVENTION

The object of the present invention is to provide an electrode assembly, a method for the production thereof and an electrochemical cell that at least partially overcome the disadvantages and restrictions that are known from the prior art.

In particular, it is intended to provide an electrode assembly and an electrochemical cell which comprises such an electrode assembly in which possible changes of the structure, for instance due to the formation of dendrites and the sheet-like deposition of active materials, are suppressed as much as possible and which, with resultant better reliability, are suitable for use in secondary batteries with higher power or energy.

Furthermore, it is intended in particular to propose a method for producing the electrode assembly which allows efficient production of the electrode assembly and/or the electrochemical cell with a small possible number of method steps.

### DISCLOSURE OF THE INVENTION

This object is achieved by an electrode assembly, a method for the production thereof and an electrochemical cell with the features of the independent patent claims. Preferred configurations, which can be realized individually or in combination, are presented in the dependent patent claims.

Hereinafter, the terms “have”, “comprise” or “include”, or any grammatical variations thereof, are used in a non-exclusive way. Accordingly, these terms may denote both situations in which there are no further features apart from the feature introduced by these terms or situations in which one or more further features are present. For example, the expression “A has B”, “A comprises B” or “A includes B” may refer both to situations in which, apart from B, no further element is present in A (i.e. to a situation in which A consists exclusively of B) and the situation in which, in addition to B, one or more further elements are present in A, for example element C, elements C and D or even further elements.

The present invention comprises in a first aspect an electrode assembly, which has a layer structure with at least one first electrode, at least one second electrode and at least one separator inserted between the first electrode and the second electrode. The “first electrode” is understood here as being a first, electrically conductive material, which according to the invention takes the form of at least one first electrically conductive band. An analogous requirement also applies to the “second electrode”, which as a second electrically conductive material takes the form of at least one electrically conductive band. The two electrodes differ here with respect to their polarity, so that, in the case where the first electrode is an anode, the second electrode represents a cathode. If, conversely, the first electrode is a cathode, the second electrode accordingly represents an anode. An “anode” is the term that is used here—in keeping with the customary definition—to refer to that electrode at which oxidation can proceed, whereby electrons can flow away from the anode by way of an current collector, whereas anions that are present in an electrolyte can move toward the anode, in order in particular to allow them to be intercalated at interstitial lattice sites in an active material which comprises the anode. By contrast, a “cathode” is the term that is used here to refer to that electrode at which a reduction can proceed, whereby electrons can flow by way of an current collector toward the cathode, whereas cations that are present in the electrolytes can likewise move toward the cathode. As long as the two electrodes have a polarity that is different from one another, it is immaterial for the electrode assembly according to the invention which of the two electrodes, i.e. the first electrode or the second electrode, actually represents a cathode or an anode.

According to the invention, each of the two electrodes respectively has an electrically conductive band. This is understood as meaning a flat flexible body of an electrically conductive material, which may be provided in particular in the form of a roll. By being given this type of form, the dimensions of the band are fixed in such a way that the length of the band is very much greater than the width of the band, while the width of the band is very much greater than the thickness of the band. The length of the band may exceed the width of the band here by a factor of 10, 100, 1000 or more, whereas the width of the band may exceed the thickness of the band by a factor of 10, 20, 50, 100 or more. The band may in particular take the form of a metal foil, a thin strip, an expanded metal and/or a woven gauze structure, which respectively comprise an electrically conductive material, in particular a metal or an alloy. In a preferred configuration, the first conductive band comprises a first metal band, which comprises at least one first metal or a first alloy, in particular copper. In this configuration, the second conductive band may have a second metal band, which may comprise at least one second metal that is different from the first metal or first alloy, in particular aluminum, or an alloy different from this.

Furthermore, the electrode assembly comprises a separator, which is inserted between the first electrode and the second electrode and takes the form of at least one electrically insulating band. A “separator” is understood here as meaning an electrically insulating device which separates the first electrode and the second electrode from one another, and in particular for this purpose keeps them a distance apart, in such a way that the two electrodes cannot build up a direct contact with one another, preferably in order to avoid a short circuit as a consequence of a direct, electrically conductive connection between the two electrodes. The form of the insulating band may preferably correspond here to the form at least of one of the electrically conductive bands, as described above or below, or it may also have a greater width, which protrudes beyond the at least one electrically conductive band. In particular, the insulating band may comprise a plastic, for instance a polyolefin, and/or a ceramic material, it being possible in a particularly preferred configuration for the plastic and/or the ceramic material to have pores, which are for instance designed for receiving the electrolyte required for the electrochemical cell and serve for being flowed through by the lithium ions.

In a preferred configuration, the separator may have at least one component part of a ceramic material, such as for example Al₂O₃ and/or SiO₂, which may in particular have a high mechanical strength, a high temperature resistance and a low shrinkage at relatively high temperatures. As a consequence of high currents during the operation of an electrode assembly, it may sometimes happen that the electrode assembly heats up greatly, the separator being susceptible to shrinkage, in particular if it is formed from a polyolefinic material, whereby direct contact between the two electrodes, and consequently overheating of the electrode assembly, may occur, whereby a fire may be started. The ceramic separator may preferably be formed from a flexible ceramic composite material. A composite material, which may also be referred to as a laminate material, may be formed from various materials that are bonded to one another, in particular from ceramic materials and from polymeric materials. For example, a nonwoven of polyethylene terephthalate (PET), which may be provided with a ceramic impregnation and/or overlay, may be suitable for this.

The ceramic separator may preferably be wetted on one side and/or on both sides of the insulating strip with an ionic liquid, which can in particular increase the flexibility of the ceramic separator and improve its adhesive attachment to at least one of the two electrodes of the electrode assembly.

The at least one separator may preferably extend at least partially over a delimiting edge of at least one, in particular neighboring electrode, particularly preferably over all the delimiting edges of in particular neighboring electrodes. In this configuration, any electrical currents between the edges of electrodes of the electrode assembly can be reduced.

According to the invention, the first conductive band is laid in the form of a first zigzag fold. A “zigzag fold”, which may also be referred to as a “Z fold”, is understood here as meaning a configuration of the first electrode as represented for example in G. Reinhart, see above, where the first conductive strip is respectively folded in certain portions in the form of first layers lying one over the other, with first folding edges that lie opposite one another being formed. The zigzag fold is therefore distinguished by the fact that a first portion of the first strip, which is referred to as the first layer, is laid onto an underlay or onto a previous first layer, the strip being turned over altogether by 180° at one end of the portion, in order in this way to form a further layer of the same strip, a folding edge thereby being formed over the width of the strip between the first layer and the further layer. This kind of arrangement is preferably provided in the same way over at least part of the strip, in particular the entire strip, so that the first conductive band takes the form of a plurality of first layers lying in parallel one over the other.

The electrode assembly also comprises a second conductive band, which is laid in the form of a second zigzag fold, whereby, by analogy with the first zigzag fold, a plurality of second layers lying in parallel one over the other is formed by the second zigzag fold, two layers of the second conductive strip that are directly adjacent one another respectively forming a second folding edge over the width of the second conductive strip.

According to the invention, the first conductive strip and the second conductive strip are thus introduced into the electrode assembly in such a way that the first layers and the second layers are aligned parallel to one another. If a first folding direction of the first zigzag fold is defined by the first folding edges of the first zigzag fold lying opposite one another and a second folding direction of the second zigzag fold is defined by second folding edges in the second zigzag fold lying opposite one another, the first folding direction and the second folding direction form an angle in relation to one another which, according to the invention, lies in a range of at least 60° and of at most 120°, preferably of at least 80° and at most of 100°, the angle particularly preferably assuming a value of 90°.

In a particularly preferred configuration of the present invention, two neighboring first layers of the first conductive band are respectively laid one over the other in such a way that they thereby form a double layer, it being possible for a second layer of the second conductive band to be respectively inserted between two double layers. In particular in this particularly preferred configuration, but without being restricted to this configuration, a first conductive band and an insulating band may in each case be guided together such that the first conductive band can form together with exactly one insulating band a plurality of first layers lying one over the other. Alternatively or else in addition to this, two insulating bands may be guided together with the second conductive band in such a way that a plurality of second layers lying one over the other can form, it being possible here for the second conductive band to be guided exactly between two of the insulating bands. The configurations described in this paragraph may ensure in particular that the two electrically conductive electrode bands can be separated from one another by preferably one or two insulating bands in such a way that an electrical contact between the electrically conductive electrode bands can be avoided.

Other configurations, which establish in what way the two layers in the electrode assembly may be arranged with respect to one another, are conceivable however. Preferably, the electrode assembly may comprise more than one first electrode and more than one second electrode, electrodes of a different polarity being respectively separated from one another by means of at least one separator. In particular, the layer structure in the electrode assembly may in each case have an electrode, which is respectively followed by a separator, which separates the electrode from the next electrode, which is preferably provided with a different polarity. Preferably, in this electrode assembly a number of electrodes of the same polarity may be respectively connected to one another in an electrically conducting manner and preferably connected to one another in parallel, but also in series.

In a particularly preferred configuration, the first conductive band and/or the second conductive band of the electrode assembly according to the invention may respectively have a first side and a second side, it being possible for the first side and/or the second side of the electrically conductive bands to be at least partially provided with an active material. This configuration may in particular provide that electrically conductive bands lying one over the other that are not separated by at least one insulating band cannot be coated with the active material. Accordingly, the first side of the first conductive band, the first side of the second conductive band and the second side of the second conductive band may be at least partially provided with the active material, while the second side of the first conductive band may remain free of active material. The coatings of the conductive bands of the electrode assembly may preferably be configured in such a way that gaps are provided between regions on the first side and/or between regions on the second side that are respectively provided with the active material, it being possible for the gaps preferably to occur at least at the first folding edges and at the second folding edges and also at contacting regions. “Contacting regions” are understood as meaning regions on the first conductive band and/or on the second conductive band that are provided for later contacting in each case with an current collector, which can establish the electrical contact with the first electrode and with the second electrode. In one particular configuration, the contacting regions may lie at peripheral regions that the first conductive band and/or the second conductive band may have. In particular for use as a contacting region, the peripheral region may at least partially have gaps; gaps in the peripheral region may however also be of advantage for instance in order to avoid the possibility that active material can become detached from the periphery of the first conductive band and/or the second conductive band.

In the case of the present invention, an “active material” is understood as meaning a lithium-containing inorganic transition metal oxide or graphite, depending on whether the cathode or the anode may be coated with the active material. For suitable active materials, reference is preferably made in this connection to the materials presented in B. Ketterer, see above, it also being possible that further materials that are known from use in other electrochemical cells may be suitable for the configuration of the electrode assembly according to the invention.

The present invention relates in a further aspect to a method for producing an electrode assembly, which has a layer structure with at least one first electrode, at least one second electrode and at least one separator inserted between the first electrode and the second electrode. The method according to the invention comprises at least steps a) to d) described below, it being possible depending on the configuration for further steps to be added. Steps a) to d) are preferably carried out in the sequence shown, while it is possible for steps a) and b) to be switched over. According to step a), a first electrode is provided in the form of a first conductive band and, according to step b), a second electrode is provided in the form of a second conductive band.

According to the invention, depending on the configuration chosen, steps c) and d) are repeated a number of times in this sequence or in the reverse sequence, whereby a plurality of first layers lying one over the other forms in the form of a first zigzag fold and a plurality of second layers lying one over the other forms in the form of a second zigzag fold. The first layers and the second layers are laid here such that they are arranged parallel to one another. First folding edges that lie opposite one another of the first zigzag fold define a first folding direction of the first zigzag fold, while second folding edges that lie opposite one another of the second zigzag fold define a second folding direction of the second zigzag fold. According to the invention, the first folding direction of the first zigzag fold and the second folding direction of the second zigzag fold here form an angle in relation to one another of at least 60° and of at most 120°, preferably of at least 80° and of at most 100°, in particular of 90°.

In a particularly preferred configuration, two neighboring first layers may be respectively laid one over the other in such a way that they respectively form a double layer, it being possible for a second layer, in particular a single second layer, to be inserted in each case between two double layers. Accordingly, in this configuration step c) may be carried out twice in succession, before step d) is respectively carried out once after that. Other configurations are conceivable. In this way, however, an electrode assembly that can have in particular the advantages listed below can be obtained.

According to the invention, the separator is also provided in the form of an insulating band, the insulating band being inserted between the first conductive band and the second conductive band in such a way that the insulating band of the separator separates the first conductive band from the second conductive band. In this way, any disadvantageous electrical contact between the first conductive band and the second conductive band is avoided.

In a particularly preferred configuration, the at least one insulating band may be provided here together with the first conductive band and/or together with the second conductive band and in particular be folded together with the respectively provided conductive band according to step c) or according to step d). In a first preferred configuration, the first conductive band may be guided together with exactly one of the at least one insulating bands. In a second, likewise preferred configuration, for this purpose the second conductive band may be guided between exactly two of the insulating bands. These configurations are advantageous in particular whenever the first conductive band forms double layers between which a second layer of the second conductive band is respectively inserted. Other configurations are conceivable however.

For further details with respect to the method according to the invention, reference is made to the electrode assembly described more specifically above and below that can be produced by this method. Depending on the configuration chosen, it is possible in particular for further, customary anode layers, separator layers, cathode layers and electrolytes to be used in all possible compositions, layer thicknesses and dimensionings. In particular, customary combinations of anodes, cathodes, a separator and an electrolyte as are used in lithium-ion or lithium-ion-polymer cells may be used.

The present invention relates in a further aspect to an electrochemical cell, which comprises at least one electrode assembly that is described above or below and/or an electrode assembly produced by the method according to the invention. The electrochemical cell also comprises at least one electrolyte, at least one first current collector for the first electrode and at least one second current collector for the second electrode. The electrochemical cell may in addition have further component parts, in particular a housing, which may surround the electrochemical cell at least partially, preferably completely apart from openings for the attachment of electrical contacts. A “housing” is understood here as meaning a material that is solid under normal conditions, which is used in particular for the purpose of separating the electrochemical cell at least partially from its surroundings. In addition, the housing may perform further functions, for instance receiving the electrolyte, preferably whenever the electrolyte is at least partially in a liquid form, so that the electrolyte in this form can be introduced into the housing in an easy way, for instance be poured in. As already described at the beginning, an “electrolyte” is the term that is used for referring to a solid or liquid substance in which the ions can move between the electrodes. In an alternative, likewise preferred configuration, the electrolyte may be provided together with the separator, for instance by the separator being impregnated with the electrolyte, for example in that the electrolyte is introduced into the pores that the separator may have.

In a preferred configuration, the first current collector and/or the second current collector may be attached at gaps between regions which are provided with the active material. In particular, the first current collector for the first electrode may be attached in particular at a first folding edge and/or in a peripheral region of the first conductive band, while the second current collector for the second electrolyte may be attached at a second folding edge and/or in a peripheral region of the second conductive band.

In a preferred configuration, the electrochemical cell may be wound with an insulating material, in particular in order advantageously to strengthen the composite bond and improve the longevity and reliability of the system. This configuration can advantageously also counteract the precipitation of materials out of the active material, for instance lithium or iron, in the form of dendrites.

The present invention relates in a further aspect to a method for producing an electrochemical cell, at least one electrode assembly described above or below, which comprises at least one first electrode, at least one second electrode and at least one separator inserted between the first electrode and the second electrode, being provided. According to the invention, for this purpose the at least one electrode assembly is provided with at least one electrolyte, at least one current collector for the first electrode and at least one second current collector for the second electrode. In a particularly preferred configuration, a separator impregnated with the electrolyte may be used for this purpose. Likewise preferred is a configuration in which the at least one electrode assembly may be at least partially surrounded by a housing, it being possible for the housing to have connections for the first current collector and connections for the second current collector. In particular in the latter configuration, the electrolyte may be provided in a liquid form and be introduced into the housing in an easy way.

The present invention relates in a further configuration to a secondary battery, which comprises at least one electrochemical cell in the way described above or below. In a particularly preferred configuration, the secondary battery may also be at least partially surrounded here by a housing, which may have electrical connections.

Not only with respect to the electrochemical cell but also with respect to the method for producing the electrochemical cell and to the secondary battery, for further particulars reference is made to the detailed description of the electrode assembly given above or below.

The electrode assembly according to the invention and an electrochemical cell which has such an electrode assembly and also a secondary battery which comprises at least one such electrochemical cell may have a series of advantages. It may be particularly advantageous here that the method according to the invention comprises a folding of the at least one first electrode, the at least one second electrode and the at least one separator inserted between the first electrode and the second electrode, it being possible for the required stacking sequence to be maintained in an easy way. The fact that the two electrodes are provided in the form of conductive bands and the separator is provided in the form of at least one insulating band makes it unnecessary to produce and position individual electrodes, whereby a major source of errors in the production process that may for example have effects in the form of particle formation, layer roughness and/or cracks in the individual electrodes can be avoided. Rather, the method according to the invention allows stacks of first layers and second layers lying one over the other to be formed from the two conductive bands, without individual electrode sheets in each case having to be cut to size, cleaned, provided, positioned and protected from electrostatic charging. In this way it is possible to obviate the need for an additional drying step, which usually involves drying and cleaning the individual electrode sheets.

The folding method according to the invention can accordingly increase the reliability of the process and the rate of production of the electrode assemblies, with at the same time an increased yield. The simultaneous bringing together of a conductive band, onto which the active material may already have been applied in the form of a thin layer, with at least one insulating separator band can significantly reduce the sources of error described above in the electrode assembly and their consequences.

The configuration according to the invention, arranging the first folding direction of the first zigzag fold and the second folding direction of the second zigzag fold at an angle in relation to one another of at least 60° and of at most 120°, preferably at right angles, can lead to better fixing of the individual electrodes within the electrode assembly and reduce possible slipping of the individual component parts in the layer structure when there is an increase in temperature. The advantageous fixing and/or the substantially orthogonal arrangement of the two folding directions in relation to one another make it possible in particular to avoid microcracks, without additional method steps, such as for instance laborious adhesive bonding or laminating operations, being required in the production of the electrode assembly. In this way it is possible to provide long-lasting electrode assemblies of improved reliability, in particular by the avoidance of microcracks in the electrodes and/or the active material. These advantages of the electrode assembly can also be found correspondingly in the electrochemical cell which comprises such an electrode assembly and also in the secondary battery which has such electrochemical cells.

To sum up, the following configurations of the present invention are preferred:

1. An electrode assembly, comprising a layer structure with at least one first electrode, at least one second electrode and at least one separator inserted between the first electrode and the second electrode, the first electrode having at least one first conductive band, the first conductive band being folded in a first zigzag fold, the first zigzag fold having the effect of forming a plurality of first layers lying one over the other, with first folding edges that lie opposite one another of the first zigzag fold defining a first folding direction of the first zigzag fold, the second electrode having at least one second conductive band, the second conductive band being folded in a second zigzag fold, the second zigzag fold having the effect of forming a plurality of second layers lying one over the other, with second folding edges that lie opposite one another of the second zigzag fold defining a second folding direction of the second zigzag fold, the first layers and the second layers being arranged parallel to one another, the first folding direction and the second folding direction forming an angle in relation to one another of at least 60° and of at most 120°, and the separator taking the form of at least one insulating band.

2. The electrode assembly according to the preceding configuration, the angle between the first folding direction and the second folding direction being 90°.

3. The electrode assembly according to one of the preceding configurations, two neighboring first layers respectively lying one over the other in such a way that they in each case form a double layer, and a second layer being respectively inserted between two double layers.

4. The electrode assembly according to one of the preceding configurations, the first conductive band forming together with exactly one of the at least one insulating bands a plurality of first layers lying one over the other.

5. The electrode assembly according to one of the preceding configurations, the at least one insulating band forming together with the second conductive band a plurality of second layers lying one over the other.

6. The electrode assembly according to the preceding configuration, the second conductive band being guided as a three-layer band between exactly two of the insulating bands.

7. The electrode assembly according to one of the preceding configurations, the first conductive band comprising a first metal band, which comprises at least one first metal.

8. The electrode assembly according to the preceding configuration, the first metal band comprising copper.

9. The electrode assembly according to one of the preceding configurations, the second conductive band comprising a second metal band, which comprises at least one second metal that is different from the first metal.

10. The electrode assembly according to the preceding configuration, the second metal band comprising aluminum.

11. The electrode assembly according to one of the preceding configurations, the insulating band comprising a plastic and/or a ceramic material.

12. The electrode assembly according to the preceding configuration, the plastic and/or the ceramic material having pores.

13. The electrode assembly according to one of the preceding configurations, the first conductive band and/or the second conductive band respectively having a first side and a second side, the first side and/or the second side being at least partially provided with an active material in such a way that bands lying one over the other that are not separated from one another by at least one insulating band are free of the active material.

14. The electrode assembly according to the preceding configuration, the active material comprising an inorganic lithium salt and/or graphite.

15. The electrode assembly according to one of the two preceding configurations, the first side of the first conductive band, the first side of the second conductive band and the second side of the second conductive band being at least partially provided with the active material, while the second side of the first conductive band is not provided with the active material.

16. The electrode assembly according to one of the three preceding configurations, gaps being provided between regions on the first side and/or the second side that are provided with the active material, at least at the first folding edges and at the second folding edges and at contacting regions.

17. The electrode assembly according to the preceding configuration, the first conductive band and/or the second conductive band having a peripheral region, the peripheral region at least partially having gaps.

18. A method for producing an electrode assembly, comprising a layer structure with at least one first electrode and at least one second electrode and also at least one separator inserted between the first electrode and the second electrode, with the steps of:
a) providing a first electrode in the form of a first conductive band;
b) providing a second electrode in the form of a second conductive band;
c) folding the first conductive band to form a first layer;
d) folding the second conductive band to form a second layer;
steps c) and d) being repeated a number of times in such a way that there form a plurality of first layers lying one over the other in the form of a first zigzag fold, with first folding edges that lie opposite one another of the first zigzag fold defining a first folding direction of the first zigzag fold, and there form a plurality of second layers lying one over the other in the form of a second zigzag fold, with second folding edges that lie opposite one another of the second zigzag fold defining a second folding direction of the second zigzag fold, the first layers and the second layers being arranged parallel to one another, the first folding direction and the second folding direction forming an angle in relation to one another of at least 60° and of at most 120°, and the separator being provided in the form of at least one insulating band, which is inserted between the first conductive band and the second conductive band in such a way that the separator separates the first conductive band from the second conductive band.

19. The method according to the preceding configuration, the angle between the first folding direction and the second folding direction being chosen as 90°.

20. The method according to one of the preceding configurations concerning the method, two neighboring first layers being respectively laid one over the other in such a way that they in each case form a double layer, and a second layer being respectively inserted between two double layers.

21. The method according to one of the preceding configurations concerning the method, the at least one insulating band being provided together with the first conductive band and/or together with the second conductive band.

22. The method according to one of the preceding configurations concerning the method, the first conductive band being guided together with exactly one of the at least one insulating bands.

23. The method according to one of the preceding configurations concerning the method, the second conductive band being guided as a three-layer band between exactly two of the insulating bands.

24. An electrochemical cell, comprising at least one electrode assembly according to one of the configurations concerning the electrode assembly, at least one electrolyte, at least one first current collector for the first electrode and at least one second current collector for the second electrode.

25. The electrochemical cell according to the preceding configuration, the first current collector and/or the second current collector being attached at gaps between regions which are provided with an active material.

26. The electrochemical cell according to the preceding configuration, the first current collector being attached at a first folding edge and/or in a peripheral region of the first conductive band and the second current collector being attached at a second folding edge and/or in a peripheral region of the second conductive band.

27. The electrochemical cell according to one of the preceding configurations concerning the electrochemical cell, the separator being at least partially impregnated with the electrolyte.

28. The electrochemical cell according to one of the preceding configurations concerning the electrochemical cell, the electrochemical cell being at least partially surrounded by a housing.

29. The electrochemical cell according to the preceding configuration, the electrolyte having been introduced in a liquid form into the housing.

30. A method for producing an electrochemical cell according to one of the configurations concerning the electrochemical cell, at least one electrode assembly comprising a layer structure with at least one first electrode, at least one second electrode and at least one separator inserted between the first electrode and the second electrode being provided, the electrode assembly being provided with at least one electrolyte, at least one first current collector for the first electrode and at least one second current collector for the second electrode.

31. The method according to the preceding configuration, a separator that is at least partially impregnated with the electrolyte being used.

32. The method according to one of the preceding configurations concerning a method for producing an electrochemical cell, the at least one electrode assembly being at least partially surrounded by a housing, the housing having connections for the first current collector and for the second current collector.

33. The method according to the preceding configuration, the electrolyte being introduced into the housing in a liquid form.

34. A secondary battery, comprising at least one electrochemical cell according to one of the configurations concerning the electrochemical cell.

35. The secondary battery according to the preceding configuration, which is at least partially surrounded by a housing and has electrical connections.

### BRIEF DESCRIPTION OF THE FIGURES

Further details and features of the invention emerge from the following description of preferred exemplary embodiments, in particular in conjunction with the subclaims. The respective features may be realized here by themselves alone or together in combination with one another. The invention is not restricted to the exemplary embodiments. The exemplary embodiments are schematically represented in the figures. The same reference numerals in the individual figures thereby denote elements that are the same or functionally the same and/or correspond to one another with regard to their functions.

Specifically:

FIG. 1 shows a perspective plan view of a first embodiment of an electrode assembly according to the invention, in which the two current collectors can be attached on sides of the electrode assembly lying opposite one another; the representation has been stretched out perpendicularly in relation to the individual layers, so that the individual layers can be seen better;

FIG. 2 shows a schematic representation of the coating of the respective first and second sides in the embodiment according to FIG. 1 with active material for the first electrode (a) and for the second electrode (b);

FIG. 3 shows the embodiment according to FIG. 1 without the spacings having been stretched out;

FIG. 4 shows a perspective representation of a second embodiment of the electrode assembly according to the invention, it being possible for the two current collectors to be attached to the two folding edges that are perpendicular to one another of the first conductive band and of the second conductive band; the representation perpendicular to the individual layers has been stretched out;

FIG. 5 shows a schematic representation of the coating of the respective first and second sides in the embodiment according to FIG. 4 with active material for the first electrode (a) and for the second electrode (b);

FIG. 6 shows the embodiment according to FIG. 4 without the spacings having been stretched out;

FIG. 7 shows a perspective representation of a further embodiment of the electrode assembly according to the invention, the second conductive band being guided between exactly two insulating bands; the representation perpendicular to the individual layers has been stretched out.

### EXEMPLARY EMBODIMENTS

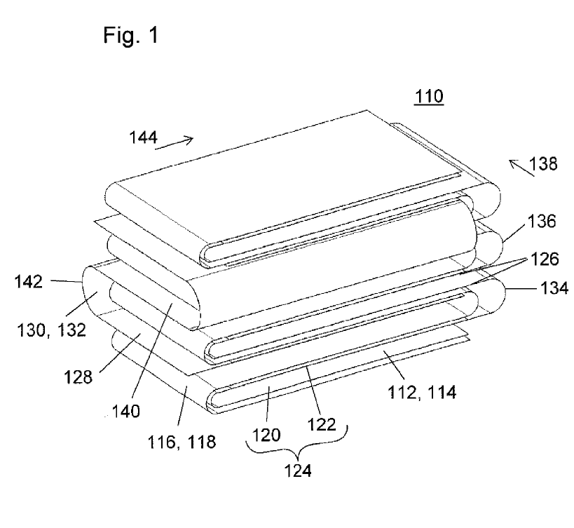

In FIG. 1, a first exemplary embodiment of an electrode assembly 110 according to the invention is perspectively represented. The electrode assembly 110 comprises a layer structure made up of a first electrode 112, which is also referred to hereinafter as the “anode” and which is guided in the form of a first conductive band 114 together with a separator 116, which takes the form of an insulating band 118. In each case two neighboring layers 120, 122 of the first conductive band 114 form a double layer 124, a second layer 128 of the second electrode 130, which is also referred to hereinafter as the “cathode”, being inserted as part of a second conductive band 132 between each double layer 124 and a further double layer 126 neighboring said first double layer. In the present embodiment, the first conductive band 114 of the first electrode 112 is folded together with the insulating band 118 of the separator 116 in the form of a first zigzag fold, there forming as a result a number of first layers 120, 122 lying one over the other and first folding edges 134, 136 lying opposite one another of the first zigzag fold. Here, the first folding edges 134, 136 that lie opposite one another define a first folding direction 138 of the first zigzag fold. In an analogous way, the second conductive band is folded in a second zigzag fold, which forms a plurality of second layers 128, 140 lying one over the other, with second folding edges 142 that lie opposite one another here too defining a second folding direction 144. According to the invention, both the first layers 120, 122 and the second layers 128, 140 are arranged parallel to one another, while the first folding direction 138 and the second folding direction 144 in the present exemplary embodiment assume an angle in relation to one another of 90°.

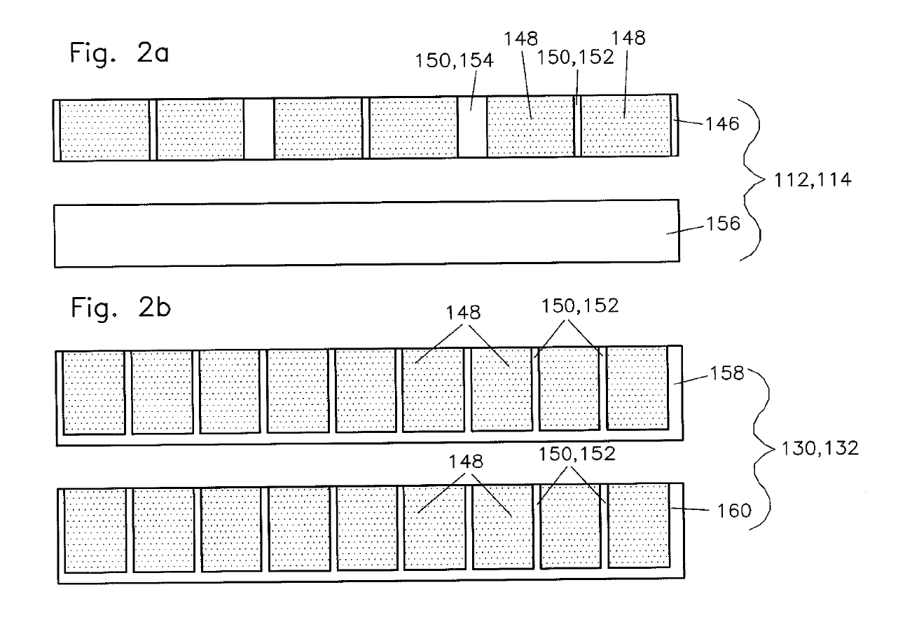

For producing the electrode assembly 110 that is represented in FIG. 1, as represented in FIG. 2a), first a first electrode 112 is provided as an anode in the form of a first conductive band 114 together with a separator 116 in the form of an insulating band 118. Here, the first conductive band 114 has a first side 146, the first side 146 being coated with an active material in regions 148, which are respectively separated from one another by gaps 150. As represented in this particularly preferred configuration, the coating gaps 150 differ in their width along the first conductive band 114, a small coating gap 152 being suitable in particular for the folding of the first conductive band 114 to form a plurality of layers 120, 122 lying one over the other in order to avoid a detachment of active material in the first folding edges 134, 136. A large coating gap 154 is likewise required for the folding when forming the layer structure of the electrode assembly 110, but may later also serve for attaching an current collector to the first electrode 112. By contrast with the first side 146, the second side 156 of the first conductive band 114 in this exemplary embodiment remains free of a coating with active material.

For producing the electrode assembly 110 according to the present exemplary embodiment, for this purpose the first side 146 of the first electrode 112 is laid onto the separator 116, which completely covers the first side 146, while the second, uncoated side 156 of the first electrode 114 lies on top, and is therefore freely accessible. This assembly, which comprises the first conductive band 114 and the separator 116, is subsequently folded in such a way that the uncoated second sides 156 of two neighboring first layers 120, 122 can directly touch and the insulating band 118 comes to lie on top. Onto the insulating band 118, lying on top, of the separator 116, there is then laid perpendicularly thereto a second layer 128 of the second conductive band 130, which is used here, without restricting the generality, as a cathode and which, as represented in FIG. 2b), has two identically formed sides 158, 160, onto which of corresponding active material have been applied in regions 148 separated by coating gaps 150.

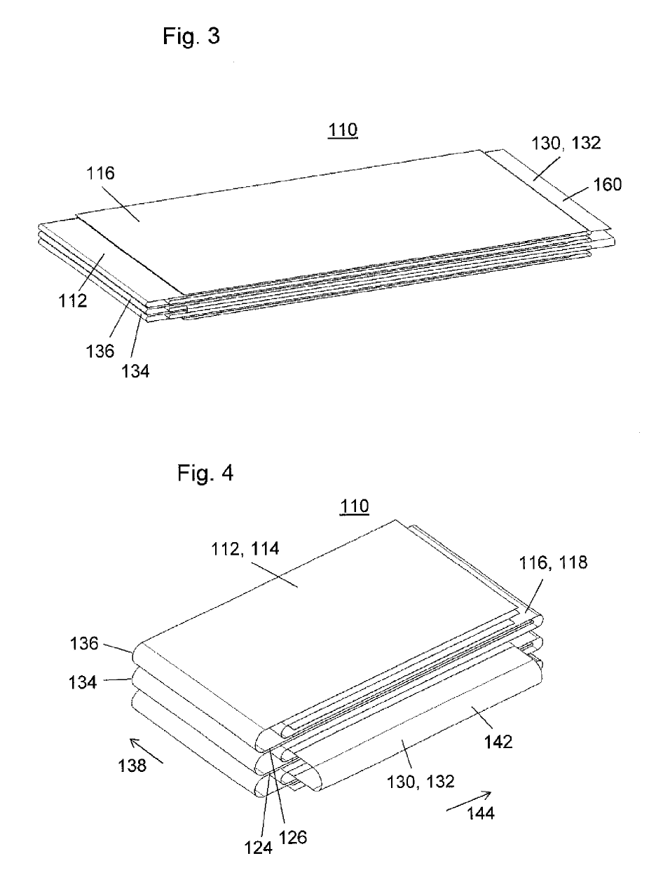

On account of the type of contacting of the second electrode 130 that is represented in FIG. 3, with an current collector, it is sufficient here to provide only small coating gaps 152. The cathode band 132 coated in this way with the active material on both sides 158, 160 is folded, whereby the cathode 130 comes up against an insulating separator band 118 on both sides 158, 160.

The band guided together from the first conductive band 114 and the insulating band 118 is subsequently folded, whereby in turn two uncoated second layers 156 of the anode band 114 are laid one over the other and the separator band 118 in turn comes to lie on top of the stack. Onto this separator band 118, lying on top, there is then again laid perpendicularly thereto by folding the cathode band 132.

By repeating the steps described, the layer structure of the electrode assembly 110 can be continued as long as sufficient bands are available, or the method may be terminated before, for whatever reason. A layer structure according to the invention is represented by way of example in FIG. 3. While a first current collector may be attached to the first folding edges 134, 136 of the first electrode 112, the respectively uncoated peripheral strip 162, which to the side of the cathode band 132 may protrude several millimeters out from the dense structure of the electrode assembly 110, may be available for the attachment of the second current collector for the cathode 130. In this way it is possible, as FIG. 3 shows, to attach the two current collectors lying opposite one another on the electrode arrangement 110.

In this exemplary embodiment, in addition, the role of cathode and anode may be switched over. Instead of the anode coated only on the first side, a cathode coated only on the first side is used, while the anode then bears a coating on the second side, as represented in FIG. 2B for the cathode, and the second side of the cathode remains free of a coating with active material.

FIGS. 4 to 6 represent a second exemplary embodiment of an electrode assembly according to the invention and a method for the production thereof, this embodiment differing from the exemplary embodiment represented in FIGS. 1 to 3 only in the possibilities for the final attachment of the current collectors. The method represented for forming the layer structure is the same, so that in this respect reference is made to the description of the first configuration. It is also possible in this exemplary embodiment, as described above for the first exemplary embodiment, to switch over the role of cathode and anode.

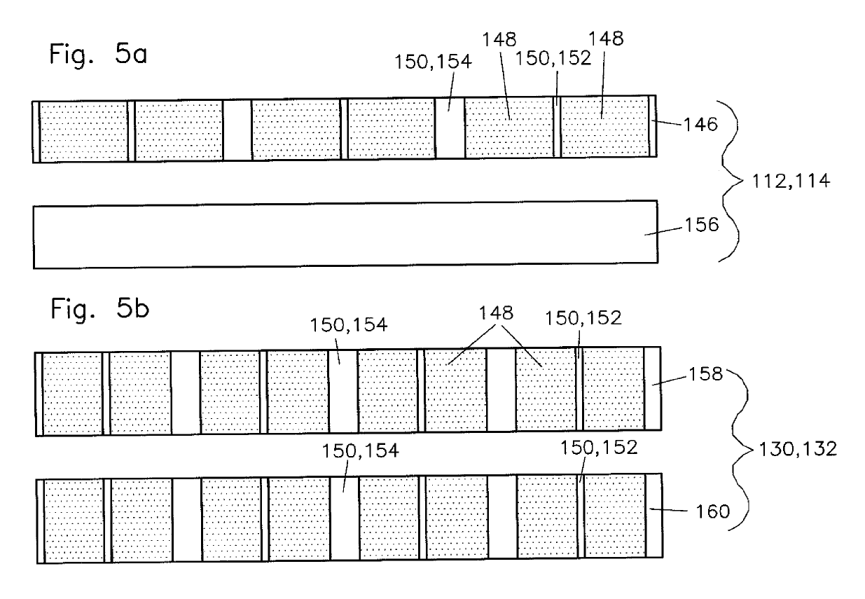

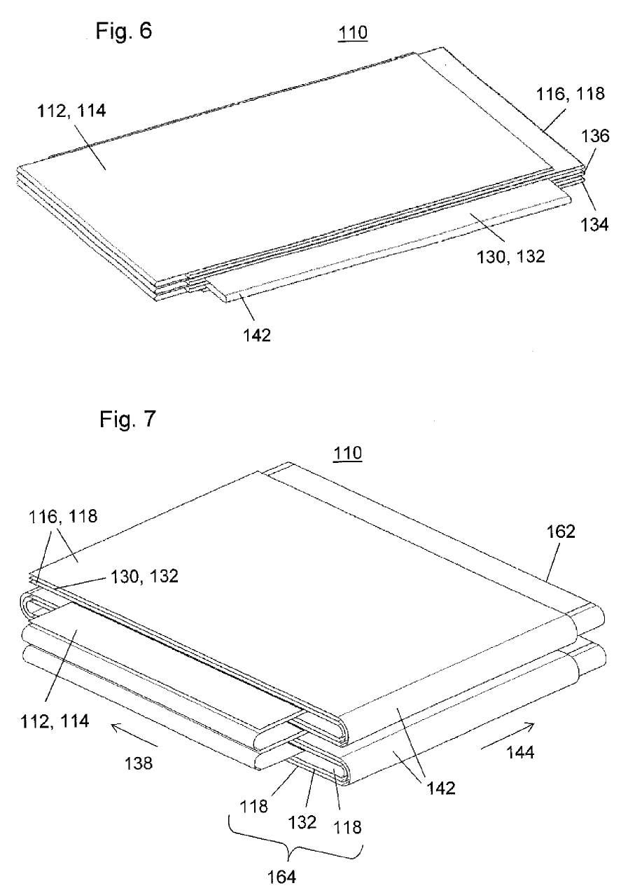

As emerges in particular from FIG. 6, in this exemplary embodiment the first folding edges 134, 136 are one above the other and provide a possibility for the attachment of a first current collector. Perpendicularly thereto, as a difference from the exemplary embodiment represented in FIGS. 1 to 3, here the second current collector is attached at at least one second folding edge 142, so that here the two current collectors are attached perpendicularly to one another on the electrode assembly 110. As FIG. 5 shows, it is however advantageous here if both the first side 158 and the second side 160 of the second conductive band 132 respectively have a coating with active material, the regions 148 that are provided with the active material being separated from one another alternately by the small coating gaps 152 and the large coating gaps 154. Here, too, the two different coating gaps 152, 154 are required for the folding of the second conductive band 132, the large coating gaps 154 being provided at those locations at which the current collector is to be attached later, which is particularly advantageous for the aforementioned reasons.

In FIG. 7, finally, a further exemplary embodiment of an electrode assembly 110 according to the invention is schematically presented in a perspective representation. In this embodiment, a three-layer band 164 is used, comprising three layers lying one over the other made up of an insulating band 118, a second conductive band 132, preferably coated on both sides 158, 160 according to FIG. 2B, and a further insulating band 118. Onto this three-layer band 164 the anode band 114 is perpendicularly laid, the regions 148 that bear a coating of the active material, which are in the same way present on the first side 146 of the anode band 114 according to FIG. 2, being oriented toward the separator band 118 and covered by it. The individually guided anode band 114 is then folded in such a way that the uncoated sides 156 of the anode band 114 come to lie on one another and touch. The three-layer band 164 made up of the separator band 118, the cathode band 132 and the further separator band 118 is subsequently laid onto that, whereby the anode band 114 previously lying on top is then in turn completely covered by the separator 116. Also in this embodiment, the layer structure of the electrode assembly 110 may be continued by repeating the stated method steps up until a termination. For the attachment of the current collector to the cathode band 132 following after the formation of the electrode assembly 110, the uncoated peripheral region 162 of the cathode band 132, which laterally protrudes several millimeters out from the electrode assembly 110, may be used. Also in this exemplary embodiment it is possible, as already described above for the first exemplary embodiment, to switch over the role of cathode and anode, it being required for this purpose to perform a coating such as that represented in FIG. 2.

### LIST OF DESIGNATIONS

110 electrode assembly

112 first electrode (anode)

114 first conductive band (anode band)

116 separator

118 insulating band (separator band)

120 first layer

122 neighboring first layer

124 double layer

126 further double layer

128 second layer

130 second electrode (cathode)

132 second conductive band (cathode band)

134 first folding edge

136 further first folding edge

138 first folding direction

140 further second layer

142 second folding edge

144 second folding direction

146 first side of the first conductive band

148 regions

150 (coating) gaps

152 small gap

154 large gap

156 second side of the first conductive band

158 first side of the second conductive band

160 second side of the second conductive band

162 peripheral region

164 three-layer band

1-10. (canceled)

11. An electrode assembly (110) comprising:
a layer structure with at least one first electrode (112), at least one second electrode (130) and at least one separator (116) inserted between the first electrode (112) and the second electrode (130);
the first electrode (112) having at least one first conductive band (114), the first conductive band (114) being folded in a first zigzag fold, the first zigzag fold having the effect of forming a plurality of first layers (120, 122) lying one over the other, wherein first folding edges (134, 136) that lie opposite of one another of the first zigzag fold define a first folding direction (138) of the first zigzag fold,
the second electrode (130) having at least one second conductive band (132), the second conductive band (132) being folded in a second zigzag fold, the second zigzag fold having the effect of forming a plurality of second layers (128, 140) lying one over the other, wherein second folding edges (142) that lie opposite of one another of the second zigzag fold define a second folding direction (144) of the second zigzag fold,
the first layers (120, 122) and the second layers (128, 140) being arranged parallel to one another, the first folding direction (138) and the second folding direction (144) forming an angle in relation to one another of at least 60° and of at most 120°, and
the separator (116) taking the form of at least one insulating band (118),
two neighboring first layers (120, 122) respectively lying one over the other in such a way that they in each case form a double layer (124, 126), and a second layer (128, 140) being respectively inserted between two double layers (124, 126).

12. The electrode assembly (110) of claim 11, wherein the first conductive band (114) forms together with exactly one of the at least one insulating bands (118) a plurality of first layers (120, 122) lying one over the other.

13. The electrode assembly (110) of claim 11, wherein the second conductive band (132) is guided as a three-layer band (164) between exactly two of the insulating bands (118), with which it together forms a plurality of second layers (128, 140) lying one over the other.

14. The electrode assembly (110) of claim 11, wherein at least one of the first conductive band (114) and the second conductive band (132) has a first side (146, 158) and a second side (156, 160), wherein at least one of the first side (146, 158) and the second side (156, 160) is at least partially provided with an active material in such a way that conductive bands lying one over the other that are not separated from one another by at least one insulating band (118) are free of the active material.

15. The electrode assembly (110) of claim 14, wherein the first side (146) of the first conductive band (114), the first side (158) of the second conductive band (132) and the second side (160) of the second conductive band (132) are at least partially provided with the active material, while the second side (156) of the first conductive band (114) is not provided with the active material.

16. The electrode assembly (110) of claim 14, wherein gaps (150) are provided between regions (148) on at least one of the first side (146, 158) and the second side (156, 160) that are provided with the active material, at least at the first folding edges (134, 136) and at the second folding edges (142) and at contacting regions.

17. The electrode assembly (110) of claim 16, wherein at least one of the first conductive band (114) and the second conductive band (132) has a peripheral region (162), the peripheral region (162) at least partially having the gaps (150).

18. A method for producing an electrode assembly (110) comprising a layer structure with at least one first electrode (112) and at least one second electrode (130) and also at least one separator (116) inserted between the first electrode (112) and the second electrode (130), the method comprising:
a) providing a first electrode (112) in the form of a first conductive band (114);
b) providing a second electrode (130) in the form of a second conductive band (132);
c) folding the first conductive band (114) to form a first layer (120, 122);
d) folding the second conductive band (132) to form a second layer (128, 140);
wherein steps c) and d) are being repeated a number of times in such a way that a plurality of first layers (120, 122) lying one over the other in the form of a first zigzag fold is formed, wherein first folding edges (134) lying opposite of one another of the first zigzag fold define a first folding direction (138) of the first zigzag fold, and that a plurality of second layers (128, 140) lying one over the other in the form of a second zigzag fold is formed, wherein second folding edges (142) lying opposite of one another of the second zigzag fold define a second folding direction (144) of the second zigzag fold, the first layers (120, 122) and the second layers (128, 140) being arranged parallel to one another, the first folding direction (138) and the second folding direction (144) forming an angle in relation to one another of at least 60° and of at most 120° , two neighboring first layers (120, 122) respectively being laid one over the other in such a way that they in each case form a double layer (124, 126), and a second layer (128, 140) being respectively inserted between two double layers (124, 126), and the separator (116) being provided in the form of at least one insulating band (118), which is inserted between the first conductive band (114) and the second conductive band (132) in such a way that the separator (116) separates the first conductive band (114) from the second conductive band (132).

19. The method of claim 18, wherein the at least one insulating band (118) is guided together with at least one of the first conductive band (114) and with the second conductive band (132).

20. The method of claim 19, wherein the first conductive band (114) is guided together with exactly one of the at least one insulating bands (118)

21. The method of claim 19, wherein the second conductive band (132) is guided as a three-layer band (164) between exactly two of the insulating bands (118).

22. An electrochemical cell, comprising at least one electrode assembly (110) of claim 11, at least one electrolyte, at least one first current collector for the first electrode (112) and at least one second current collector for the second electrode (130).

23. The electrochemical cell of claim 22, wherein at least one of the first current collector and the second current collector is being attached at gaps (150) between regions which are provided with an active material.

24. The electrochemical cell of claim 22, wherein the separator (116) is at least partially impregnated with the electrolyte or the electrolyte has been introduced in a liquid form into a housing which at least partially surrounds the electrochemical cell.

25. A secondary battery, comprising at least one electrochemical cell of claim 22.
